(19) United States
(12) Patent Application Publication
(10) Pub. No.: US 2018/0034944 A1
(43) Pub. Date: Feb. 1, 2018

(54) RADIO ACCESS ENTITY

(71) Applicant: Deutsche Telekom AG, Bonn (DE)

(72) Inventor: Gerd Zimmermann, Weiterstadt (DE)

(21) Appl. No.: 15/660,976

(22) Filed: Jul. 27, 2017

(30) Foreign Application Priority Data
Jul. 29, 2016 (EP) 16181833.1

(51) Int. Cl. H04L 29/06; H04L 29/08

(52) U.S. Cl. CPC H04L 69/08; H04L 69/324; H04W 80/02

(57) ABSTRACT

A radio access entity includes: a first communication interface for receiving a communication packet, wherein the communication packet comprises useful data and supplementary data; a processor configured to separate the useful data from the supplementary data, to transfer the useful data into a first data packet and to transfer the supplementary data into a second data packet; and a second communication interface configured to send out the first data packet according to a first data transmission protocol and to send out the second data packet according to a second data transmission protocol, wherein the first data transmission protocol and the second data transmission protocol are different from one another.

### CROSS-REFERENCE TO RELATED APPLICATIONS

Priority is claimed to European Patent Application No. EP 16181833.1, filed on Jul. 29, 2016, the entire disclosure of which is hereby incorporated by reference herein.

### FIELD

The present invention relates to the radio access to a wireless communication network.

### BACKGROUND

In modern communication networks, communication packets are assembled according to a communication protocol, for example the Internet protocol. In the field of radio access, the communication packets are transmitted via radio to a mobile communication device using a wireless data transmission technology, such as Long-Term Evolution (LTE) or Universal Mobile Telecommunications Service (UMTS), or are received from the mobile communication device. Communication with the mobile communication device is usually carried out by a wireless transmission technology, such as LTE.

A mobile communication device usually has, however, a plurality of communication interfaces, such as wireless local area network (WLAN) and LTE or UMTS, which are not collectively used for communicating communication packets.

### SUMMARY

In an exemplary embodiment, the present invention provides a radio access entity. The radio access entity includes: a first communication interface for receiving a communication packet, wherein the communication packet comprises useful data and supplementary data; a processor configured to separate the useful data from the supplementary data, to transfer the useful data into a first data packet and to transfer the supplementary data into a second data packet; and a second communication interface configured to send out the first data packet according to a first data transmission protocol and to send out the second data packet according to a second data transmission protocol, wherein the first data transmission protocol and the second data transmission protocol are different from one another.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a communication system comprising a radio access entity;

FIG. 2 shows a mobile communication device;

FIG. 3 shows a communication subnetwork; and

FIG. 4 shows a communication subnetwork.

### DETAILED DESCRIPTION

Exemplary embodiments of the present invention provide for efficiently communicating communication packets in the aforementioned manner, in which a plurality of communication interfaces of the mobile device, for example a smartphone, are used.

Communication packets usually comprise useful data, also known as payload, and supplementary data, such as control data and/or overhead. In an exemplary embodiment, the useful data and the supplementary data can be separated from one another and transmitted separately, using different data transmission technologies. These data can be assembled or separated from one another in the field of radio access.

According to a first aspect, the invention relates to a radio access entity comprising a first communication interface for receiving a communication packet, wherein the communication packet comprises useful data and supplementary data, a processor configured to separate the useful data from the supplementary data, to transfer the useful data into a first data packet and to transfer the supplementary data into a second data packet, and a second communication interface configured to send out the first data packet according to a first data transmission protocol and to send out the second data packet according to a second data transmission protocol, wherein the first data transmission protocol and the second data transmission protocol are different from one another.

The data packets can be transmitted to and from a mobile communication device via a radio access network (RAN).

In one embodiment, the first communication interface is a radio interface, for example a UMTS or LTE communication interface.

In one embodiment, the processor is configured to extract the useful data and the supplementary data from the communication packet, in particular from a data frame of the communication packet. For this purpose, the processor can be configured to implement a protocol, to which the communication packet is subject, for example the Internet protocol, in order to extract the useful data and the supplementary data from the communication packet.

In one embodiment, the first data packet and the second data packet are IP data packets (IP: Internet protocol). For this purpose, the processor can be configured to implement the IP protocol in order to assemble the data packets in accordance with the IP protocol.

In one embodiment, the useful data are payload data and/or the supplementary data are control data or overhead data, in accordance with the IP protocol for example.

In one embodiment, the first data transmission protocol and the second data transmission protocol are one of the following wireless data transmission protocols: LTE, UMTS, Global System for Mobile Communications (GSM), High Performance Radio LAN (HiperLAN) or WLAN. In this respect, the data transmission protocols determine the aforementioned data transmission technologies.

In one embodiment, the second communication interface comprises a first communication port for sending out the first data packet according to the first data transmission protocol or data transmission technology and a second communication port for sending out the second data packet according to the second data transmission protocol or data transmission technology. As a result, it is possible for the first data packet and the second data packet to be sent out independently of one another. The communication ports can also be configured to receive first data packets and second data packets that transport useful data and supplementary data for a communication data packet separately.

According to a second aspect, the invention relates to a mobile communication device, for example a smartphone, comprising a first communication interface for receiving a first data packet according to a first data transmission protocol, wherein the first data packet comprises useful data for a communication packet, a second communication interface for receiving a second data packet according to a second data transmission protocol, wherein the second data packet comprises supplementary data for the communication packet, and a processor configured to assemble the communication packet from the useful data and the supplementary data.

In one embodiment, the mobile communication device is configured to communicate with the radio access entity according to the first aspect.

In one embodiment, the processor is configured to manipulate the useful data on the basis of the supplementary data. The supplementary data may be, for example, control data for manipulating the useful data.

In one embodiment, the processor is configured to split a transmission data packet, which comprises useful data and control data, into a first data packet containing useful data and a second data packet containing control data, wherein the first communication interface is configured to send out the first data packet according to the first data transmission protocol, and wherein the second communication interface is configured to send out the second data packet according to the second data transmission protocol. The first data packet and the second data packet can be sent to the radio access entity according to the first aspect. This results in the communication resources of the mobile communication device being used in an efficient manner.

According to a third aspect, the invention relates to a communication subnetwork in a communication network comprising a plurality of subnetworks, comprising the radio access entity according to the first aspect, wherein the second communication interface is configured to receive or send the first data packet according to the first data transmission protocol and to receive or send the second data packet separately from the first data packet according to the second data transmission protocol.

In one embodiment, the communication subnetwork comprises an additional network entity configured to communicate with the radio access entity.

In one embodiment, the additional network entity is a router.

In one embodiment, the additional network entity is configured to receive the first data packet and the second data packet separately from one another, for example from the mobile communication device according to the second aspect.

In one embodiment, the processor is configured to assemble a communication packet from the first data packet and the second data packet, wherein the first communication interface of the radio access entity is configured to send the communication packet to the additional network entity.

In one embodiment, the second communication interface is configured to communicate with the mobile communication device according to the second aspect.

In one embodiment, the communication subnetwork is a communication subnetwork, in particular a slice, in 5G technology.

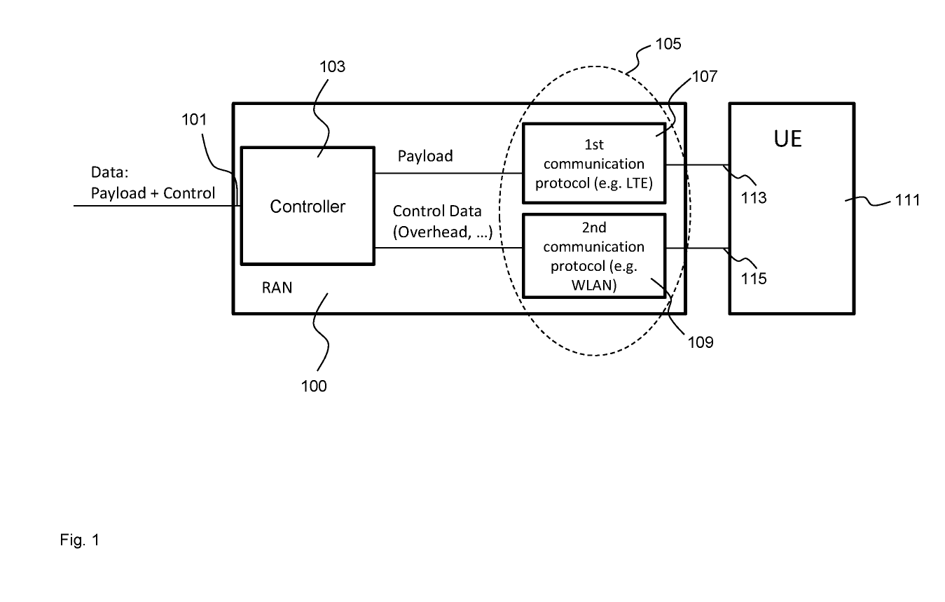

FIG. 1 shows a communication system comprising a radio access entity 100 comprising a first communication interface 101 for receiving a communication packet, wherein the communication packet comprises useful data and supplementary data, a processor 103 configured to separate the useful data from the supplementary data, to transfer the useful data into a first data packet and to transfer the supplementary data into a second data packet, and a second communication interface 105 configured to send out the first data packet according to a first data transmission protocol and to send out the second data packet according to a second data transmission protocol, wherein the first data transmission protocol and the second data transmission protocol are different from one another.

The second communication interface may comprise a first communication port 107 which operates according to the first data transmission protocol and a second communication port 109 which operates according to the second data transmission protocol.

The data stream travelling to the mobile terminal, e.g. user equipment (UE), contains payload and control data. In the RAN comprising the radio access entity 100, payload and control data are separated and transmitted to the UE via different RAN resources, such as LTE and WLAN.

The controller or processor 103 implements a protocol stack in order to unpack the data packets and split said data packets into separate packets according to the data type (payload or overhead/control), which separate packets are transmitted to the UE via different RAN channels.

The mobile terminal 111 (communication device) for example:

assembles the data (payload+control), or
processes payload on the basis of control, i.e. the data packets are not assembled, but rather processed separately.

In this manner, the available RAN diversity is used in order to increase the transmission capacity.

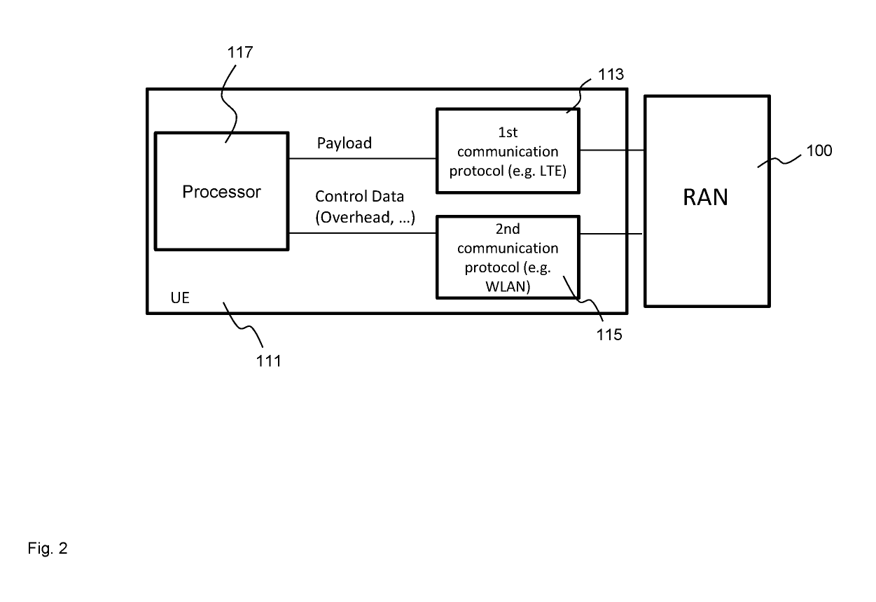

FIG. 2 shows a mobile communication device 111 comprising a first communication interface 113 for sending or receiving a first data packet according to a first data transmission protocol, wherein the first data packet comprises useful data for a communication packet, a second communication interface 115 for sending or receiving a second data packet according to a second data transmission protocol, wherein the second data packet comprises supplementary data for the communication packet, and a processor 117 configured to assemble the communication packet from the useful data and the supplementary data.

In one embodiment, the processor 117 is configured to split a transmission data packet, which comprises useful data and control data, into a first data packet containing useful data and a second data packet containing control data, wherein the first communication interface 113 is configured to send out the first data packet according to the first data transmission protocol, and wherein the second communication interface 115 is configured to send out the second data packet according to the second data transmission protocol.

The first data packet and the second data packet can be received by the radio access entity 100 of which the processor 103 is configured to assemble a communication packet from the first data and the second data, for example in accordance with the IP protocol. The communication packet can then be sent out via the communication interface 101.

In the UE 111, the data packets can be split into two subpackets containing payload and control data, respectively. By analogy with the case of downloading, the subpackets are sent to the RAN comprising the radio access entity 100 using various communication protocols. For this purpose, the UE can comprise separate communication interfaces (e.g. two antennas). Alternatively, the antennas in the UEs can be actuated separately (antenna diversity).

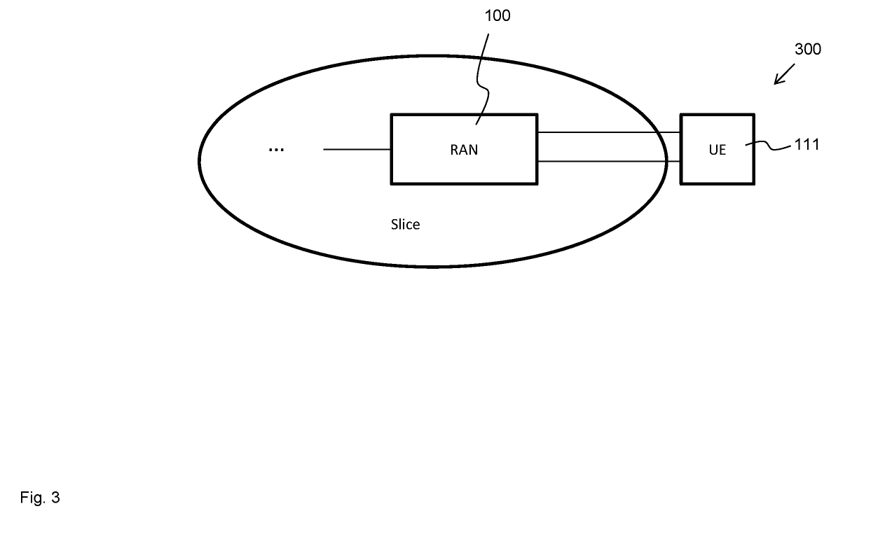

FIG. 3 shows a communication subnetwork 300 in a communication network (not shown) comprising a plurality of subnetworks, comprising the radio access entity 100, wherein the second communication interface is configured to receive or send the first data packet according to the first data transmission protocol and to receive or send the second data packet separately from the first data packet according to the second data transmission protocol.

The communication subnetwork 300 may be a slice of a 5G communication network which brings about the splitting of the communication packet into the first data packet and the second data packet and/or brings about the assembly of the communication packet from the first data packet and the second data packet.

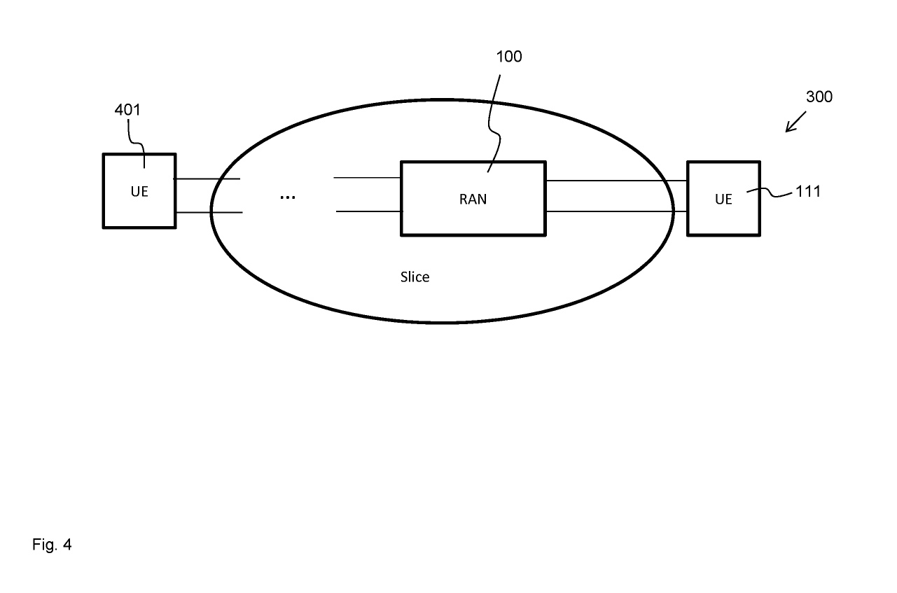

FIG. 4 shows an embodiment of the communication subnetwork 300 in which the first data packet and the second data packet are transmitted separately from one another between the mobile communication device 111 and another mobile communication device 401, for example.

The communication devices 111 and 401 can have the same features.

The communication subnetwork 300 can comprise additional network entities, such as a router or an additional radio access entity.

In one embodiment, the communication subnetwork 300 is a point-to-point communication network.

The RAN slice 300 can be provided as a service and can be made available for each of the UEs that allow for the data splitting. The RAN slice 300 may receive its own slice address or its own slice identifier.

In the embodiment shown in FIG. 4, the separated data packets (subpackets) can be transmitted, separately from one another, to an additional UE 401 via the slice.

The data transmission protocols can, for example, define the aforementioned data transmission technologies.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radio access entity, comprising:
a first communication interface for receiving a communication packet, wherein the communication packet comprises useful data and supplementary data;
a processor configured to separate the useful data from the supplementary data, to transfer the useful data into a first data packet and to transfer the supplementary data into a second data packet; and
a second communication interface configured to send out the first data packet according to a first data transmission protocol and to send out the second data packet according to a second data transmission protocol, wherein the first data transmission protocol and the second data transmission protocol are different from one another.

2. The radio access entity according to claim 1, wherein the processor is configured to extract the useful data and the supplementary data from the communication packet.

3. The radio access entity according to claim 1, wherein the first data packet and the second data packet are IP data packets.

4. The radio access entity according to claim 1, wherein the useful data are payload data, and/or wherein the supplementary data are control data or overhead data.

5. The radio access entity according to claim 1, wherein the first data transmission protocol and the second data transmission protocol are one of the following wireless data transmission protocols: Long-Term Evolution (LTE), Universal Mobile Telecommunications Service (UMTS), Global System for Mobile Communications (GSM), High Performance Radio LAN (HiperLAN) or Wireless Local Area Network (WLAN).

6. The radio access entity according to claim 1, wherein the second communication interface comprises a first communication port for sending or receiving the first data packet according to the first data transmission protocol and a second communication port for sending or receiving the second data packet according to the second data transmission protocol.

7. A mobile communication device, comprising:
a first communication interface for receiving a first data packet according to a first data transmission protocol, wherein the first data packet comprises useful data for a communication packet;
a second communication interface for receiving a second data packet according to a second data transmission protocol, wherein the second data packet comprises supplementary data for the communication packet; and
a processor configured to assemble the communication packet from the useful data and the supplementary data.

8. The mobile communication device according to claim 7, wherein the processor is configured to manipulate the useful data on the basis of the supplementary data.

9. The mobile communication device according to claim 7, wherein the processor is configured to split a transmission data packet, which comprises useful data and control data, into a first data packet for transmission containing useful data and a second data packet for transmission containing control data;
wherein the first communication interface is configured to send out the first data packet for transmission according to the first data transmission protocol; and
wherein the second communication interface is configured to send out the second data packet for transmission according to the second data transmission protocol.

10. A communication subnetwork in a communication network comprising a plurality of communication subnetworks, the communication subnetwork comprising:
a radio access entity comprising:
a first communication interface for receiving a communication packet, wherein the communication packet comprises useful data and supplementary data;
a processor configured to separate the useful data from the supplementary data, to transfer the useful data into a first data packet and to transfer the supplementary data into a second data packet; and
a second communication interface configured to send out the first data packet according to a first data transmission protocol and to send out the second data packet according to a second data transmission protocol,
wherein the first data transmission protocol and the second data transmission protocol are different from one another, and
wherein the second communication interface is configured to receive or send the first data packet according to the first data transmission protocol and to receive or send the second data packet separately from the first data packet according to the second data transmission protocol.

11. The communication subnetwork according to claim 10, further comprising:
an additional network entity, configured to communicate with the radio access entity.

12. The communication subnetwork according to claim 11, wherein the additional network entity is a router.

13. The communication subnetwork according to claim 11, wherein the additional network entity is configured to receive the first data packet and the second data packet separately from one another.

14. The communication subnetwork according to claim 11, wherein the processor of the radio access entity is configured to assemble a communication packet from the first data packet and the second data packet, and wherein in the first communication interface of the radio access entity configured to send the communication packet to the additional network entity.

15. The communication subnetwork according to claim 10, wherein the radio access entity is configured to communicate with a mobile communication device.

16. The communication subnetwork according to claim 10, wherein the communication subnetwork is a point-to-point communication subnetwork.

17. The communication subnetwork according to claim 16, wherein the point-to-point communication subnetwork is a 5G slice.
